(19) United States
(12) Patent Application Publication
(10) Pub. No.: US 2026/0145609 A1
(43) Pub. Date: May 28, 2026

(54) HEATER ASSEMBLY FOR BULK LIQUID TANK TRAILERS

(71) Applicant: Parrish Enterprises, Ltd., Enid, OK (US)

(72) Inventor: David Palmer, Enid, OK (US)

(21) Appl. No.: 19/400,768

(22) Filed: Nov. 25, 2025

Related U.S. Application Data
(60) Provisional application No. 63/725,249, filed on Nov. 26, 2024.

(51) Int. Cl. B60P 3/22; B60D 1/62; B60R 16/033; F24H 1/00; F24H 1/12; G07C 5/10; H02M 7/44; H05B 1/02

(52) U.S. Cl. CPC B60P 3/2295; B60P 3/225; B60R 16/033; F24H 1/009; F24H 1/122; G07C 5/10; H02M 7/44; H05B 1/0244; B60D 1/62

(57) ABSTRACT

A system and method for maintaining the temperature of cargo within a liquid transport trailer while in transit. The system is used with a truck having a source of 12-volt direct current (DC) electric power and a liquid transport trailer having a heat exchange tube containing a heating liquid. The heating system includes an electric inverter that is electronically connected to the DC power source, the inverter being configured to convert the 12-volt DC power to 120-volt alternating current (AC). A resistance-type AC electric heater and an electric liquid pump circulate the heating liquid through the heat exchange tube, with the heater being supplied with the 120-volt AC power from the inverter. The heater is configured to maintain the heating liquid at a pre-set operating temperature sufficient to overcome thermal losses and hold the cargo at a desired temperature.

### CROSS-REFERENCE TO RELATED APPLICATIONS

This application claims the benefit of U.S. Provisional Application No. 63/725,249, filed Nov. 26, 2024, which is hereby incorporated herein by reference in its entirety.

### BACKGROUND

Trailers of the type that transport cargo often require that the cargo be maintained at a predetermined temperature. These insulated trailers are commonly built and referenced in the industry under DOT 407. The cargo may include food-grade liquids such as chocolate, honey, or syrup. They could be chemical products sensitive to temperature fluctuation, such as MDI (methylene diphenyl diisocyanate) and TDI (toluene diisocyanate). Acids, resins, coatings, and waxes are other temperature-sensitive products. Many high-wax crude deliveries must be held at a temperature no higher than 180° F., or they cannot be removed from or delivered to the trailers. Additionally, some chemical products, such as certain resins, coatings, or highly viscous materials, must be maintained at or above a predetermined minimum temperature, typically 180° F. or higher, to remain pumpable. Therefore, the cargo must often be held within a set temperature range to ensure safe and efficient delivery and unloading.

An insulated trailer is used to transport temperature-sensitive products. The majority of insulated trailers have a heat-exchange tube that runs from end to end, starting and stopping at the front head, providing a heated liquid source (in-transit heat) to keep the payload warm or to preheat the load with steam before the unit goes on the road. These trailers are heavily insulated. In ideal conditions, with mild ambient temperatures and low wind speed, heat loss can be characterized by a temperature drop of approximately 2° F. over 24 hours. It is understood that the actual rate of heat loss depends on numerous variables, including the fluid temperature, the ambient temperature, the wind speed, and the condition of the insulation.

The heated fluid circulated through the heat exchange tube has been coolant/antifreeze (e.g., ethylene glycol or propylene glycol). A hose extends from the engine heater located under the cab of the tractor and is connected to the closed-looped tube at the front of the trailer. This requires additional coolant (e.g., eight gallons) to be added to the coolant reservoir. There is no control other than a simple bypass tube that connects the in and out of the fittings in front of the trailer.

There are many downfalls to using engine-heated coolant. First, contamination from older engines and different types of manufactured trucks, which combine various types of coolant and water-to-coolant ratios. Second, newer engines operate at significantly lower temperatures than older engines. As such, when connected to the closed-loop tube of the trailer, the tractor's computer enters fault mode, causing the tractor to undergo regeneration, a component of the environmental protection system for the tractor's engines. The payload is heated to the same temperature as the engine. Heading over a mountain pass on a hundred-degree day versus idling during a snowstorm while the driver sleeps. The temperature variances are wild and primarily uncontrollable. Many engine manufacturers have now mandated that their engines cannot be used as an in-transit heat source, as this will void the engine warranty.

Second, the driver must lift the hood of the tractor to access the radiator overfill reservoir on the engine. Accessing the reservoir requires the driver to climb on the driver's side front tire to reach the overflow reservoir. During the night or in inclement weather, this can be extremely dangerous. During windy conditions, there is a risk that the hood may close on the driver.

Many other options for heating fluid are on the market, but they all use an open flame. These prior art systems often draw fuel (such as diesel) from the tractor's tank to create heat. However, in the liquid transport industry, you cannot use an open flame when transporting flammable or combustible liquids. Furthermore, ignition sources are prohibited from being brought into refineries, chemical plants, or batch plants.

To this end, there is a need for an apparatus for heating and circulating a fluid within a trailer. To such an apparatus, the inventive concepts disclosed and claimed herein are directed.

### BRIEF DESCRIPTION OF THE DRAWINGS

To assist those of ordinary skill in the relevant art in making and using the inventive concepts disclosed herein, reference is made to the appended drawings and schematics, which are not intended to be drawn to scale, and in which like reference numerals are intended to refer to the same or similar elements for consistency. For purposes of clarity, not every component may be labeled in every drawing. Certain features and certain views of the figures may be shown exaggerated and not to scale or in schematic form in the interest of clarity and conciseness. In the drawings:

FIG. 1 is a side elevational view of a tractor and trailer, including a heater assembly constructed in accordance with the inventive concepts disclosed herein.

FIG. 2 is a perspective view of the heater assembly.

FIG. 3 is a perspective view of the heater assembly of FIG. 2 with a cabinet door in an open position.

FIG. 4 is a front elevational view of the heater assembly of FIG. 3.

FIG. 5 is a perspective, cross-sectional view taken along line 5-5 of FIG. 2.

FIG. 6 is a cross-sectional view taken along line 6-6 of FIG. 2.

FIG. 7 is a side elevational view of the heater assembly of FIG. 3

FIG. 8 is a bottom view of the heater assembly showing the fluid flow path.

FIG. 9 is a front elevational view of the heater assembly showing the fluid flow path.

FIG. 10 is a block diagram of at least a portion of the heater assembly.

### DETAILED DESCRIPTION OF EXEMPLARY EMBODIMENTS

The inventive concepts disclosed herein are directed to a heating system for a tractor having a source of direct current DC electric power and a liquid transport trailer having a closed-loop heat exchange tube with an inlet end, an outlet end, and a heating liquid disposed in the closed-loop tube. The heating system has an electric inverter electrically connected to the DC electric power source of the tractor to change the direct current to alternating current. The heating system also has a resistance-type alternating current (AC) electric liquid heater having an inlet fluidly connected to the outlet of the closed-loop tube and an outlet. The AC electric liquid heater is electrically connected to the electric inverter. An electric liquid pump has an inlet fluidly connected to the outlet of the closed-loop tube and an outlet fluidly connected to the inlet of the electric liquid heater. The pump is electrically connected to the source of direct current DC electric power or the inverter, for example. The electric liquid heater maintains the heating liquid at a pre-set operating temperature in a continuous manner for prolonged periods of time. The pre-set operating temperature of the heating liquid is determined based on the desired temperature of the cargo and the estimated thermal losses of the system, such that the heating liquid temperature is set to a predetermined temperature differential above the desired cargo temperature to facilitate effective and continuous heat transfer.

In some embodiments, the liquid transport trailer is sufficiently insulated that the electric liquid heater does not need to actively control the temperature of a temperature-sensitive material being transported by the liquid transport trailer. When the temperature-sensitive material is loaded into the liquid transport trailer, the driver can set the electric liquid heater to the desired temperature of the temperature-sensitive material (e.g., 120° F.) at the time of loading. This can be accomplished with an input device, such as a keypad connected to the electric liquid heater, or as part of the electric liquid heater itself. The electric liquid heater may be sized such that the electric liquid heater supplies heat at a level to maintain the temperature-sensitive material's temperature, but not to increase or otherwise control the temperature-sensitive material's temperature. In some embodiments, the electric liquid heater is designed to maintain the temperature-sensitive material's temperature when the material is loaded, but is not designed to control the temperature of the temperature-sensitive material.

Before explaining at least one embodiment of the inventive concept(s) in detail by way of exemplary drawings, experimentation, results, and laboratory procedures, it is to be understood that the inventive concept(s) is not limited in its application to the details of construction and the arrangement of the components set forth in the following description or illustrated in the drawings, experimentation and/or results. The inventive concept(s) are capable of other embodiments or being practiced or carried out in various ways. The language used herein is intended to be given the broadest possible scope and meaning, and the embodiments are meant to be exemplary, not exhaustive. Also, it is to be understood that the phraseology and terminology employed herein are for the purpose of description and should not be regarded as limiting.

Unless otherwise defined, scientific and technical terms used in connection with the presently disclosed and claimed inventive concept(s) shall have the meanings commonly understood by those of ordinary skill in the art. Furthermore, unless otherwise indicated by context, singular terms shall be understood to include pluralities, and plural terms shall be understood to include the singular. The foregoing techniques and procedures are generally performed according to conventional methods well known in the art and as described in various general and more specific references cited and discussed throughout the present specification.

All the articles, compositions and/or methods disclosed and claimed herein can be made and executed without undue experimentation, given the present disclosure. While the articles, compositions, and methods of the inventive concept(s) have been described in terms of preferred embodiments, it will be apparent to those of skill in the art that variations may be applied to the articles, compositions and/or methods and in the steps or in the sequence of steps of the methods described herein without departing from the concept, spirit and scope of the inventive concept(s). All such similar substitutes and modifications apparent to those skilled in the art are deemed to be within the spirit, scope, and concept of the inventive concept(s) as defined by the appended claims.

As utilized under the present disclosure, the following terms, unless otherwise indicated, shall be understood to have the following meanings:

The use of the word “a” or “an” when used in conjunction with the term “comprising” in the claims and/or the specification may mean “one,” but it is also consistent with the meaning of “one or more,” “at least one,” and “one or more than one.”

The use of the term “or” in the claims is used to mean “and/or” unless explicitly indicated to refer to alternatives only or the alternatives are mutually exclusive, although the disclosure supports a definition that refers to only alternatives and “and/or.”

Throughout this application, the term “about” is used to indicate that a value includes the inherent variation of error for the device, the method being employed to determine the value, or the variation that exists among the study subjects.

The use of the term “at least one” will be understood to include one as well as any quantity more than one, including but not limited to 2, 3, 4, 5, 10, 15, 20, 30, 40, 50, 100, etc. The term “at least one” may extend up to 100 or 1000 or more, depending on the term to which it is attached; in addition, the quantities of 100/1000 are not to be considered limiting, as higher limits may also produce satisfactory results. In addition, the use of the term “at least one of X, Y, and Z” will be understood to include X alone, Y alone, and Z alone, as well as any combination of X, Y, and Z.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if the order is important in a particular context, also BA, CA, CB, CBA, BCA, ACB, BAC, or CAB. Continuing with this example, expressly included are combinations that contain repeats of one or more items or terms, such as BB, AAA, MB, BBC, ABC, CBA, CABABB, and so forth. The skilled artisan will understand that, typically, there is no limit on the number of items or terms in any combination unless otherwise apparent from the context.

In the following detailed description of embodiments of the inventive concept, numerous specific details are set forth in order to provide a more thorough understanding of the inventive concept. However, it will be apparent to one of ordinary skill in the art that the inventive concept within the disclosure may be practiced without these specific details. In other instances, well-known features have not been described in detail to avoid unnecessarily complicating the instant disclosure.

Finally, as used herein, any reference to “one embodiment” or “an embodiment” means that a particular element, feature, structure, or characteristic described in connection with the embodiment is included in at least one embodiment. The appearances of the phrase “in one embodiment” in various places in the specification do not necessarily refer to the same embodiment.

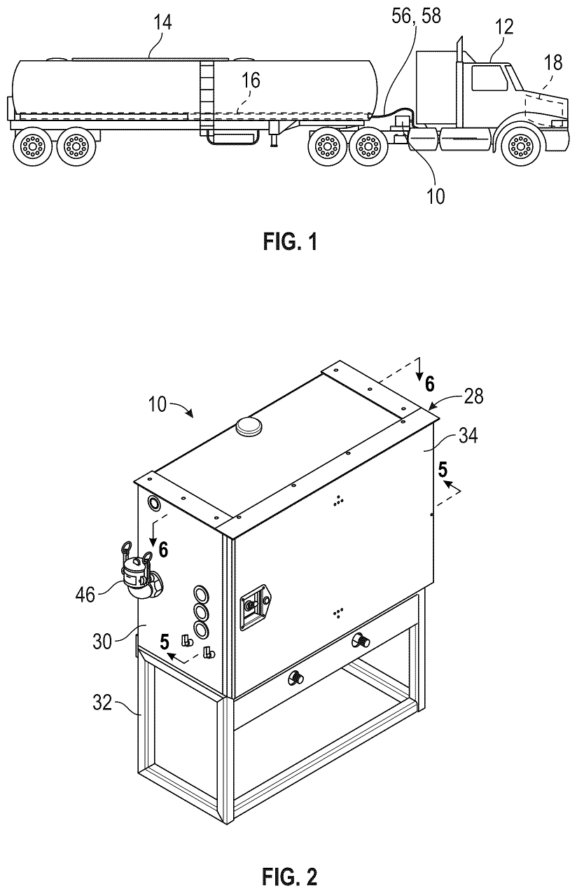

Referring to the drawings, and more particularly to FIG. 1, a transport heating apparatus 10 constructed in accordance with the inventive concepts disclosed herein is shown mounted on a truck 12 (also known as a tractor). The truck 12 is connected to a liquid transport trailer 14 filled with a temperature-sensitive material, such as chocolate. The heating system 10 may alternatively be mounted on the trailer 14. The trailer 14 includes a heat exchange tube 16 for circulating a heating liquid therethrough, such as glycol, either ethylene glycol or propylene glycol as appropriate. Conventionally, the heat exchange tube 16 is coupled in flow communication with the coolant system for an engine 18 of the truck 12 to circulate engine coolant from the engine 18 to the heat exchange tube 16 and return to the engine 18 while the engine 18 is operating. As discussed above, there are many downfalls to using engine-heated coolant. The engine 18 of the truck 12 has a source 19 of direct current DC electric power. In one embodiment, the source 19 may be a high-output alternator supplying 12 Volt DC electricity, with a capacity generally ranging from approximately 240 amps to 400 amps or greater to ensure sufficient power is available for both the electric liquid heater and the vehicle's essential systems.

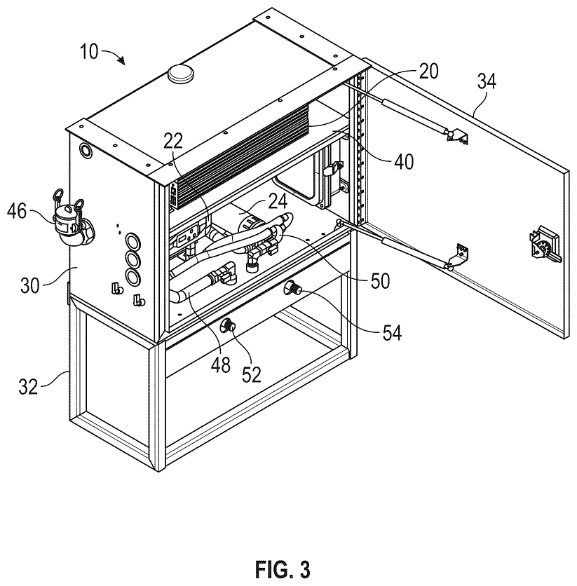

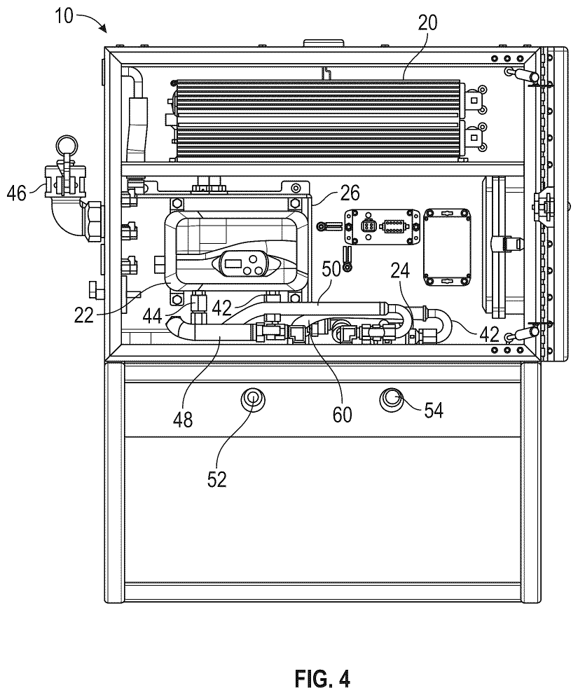

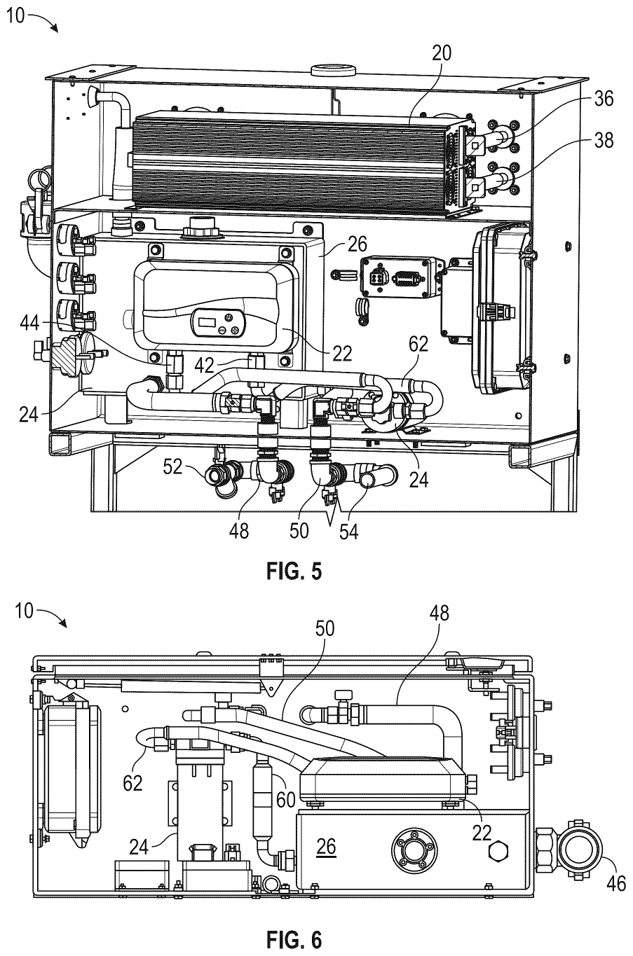

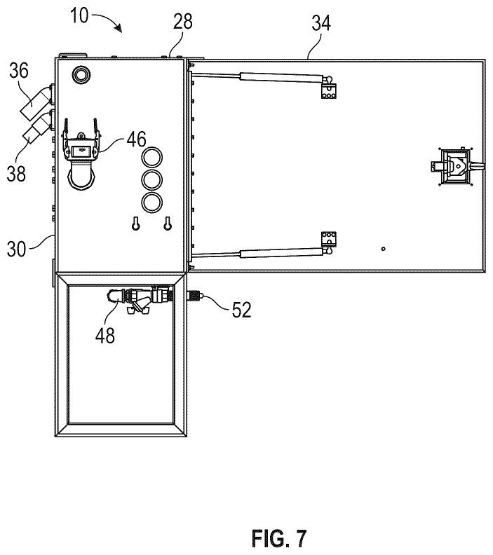

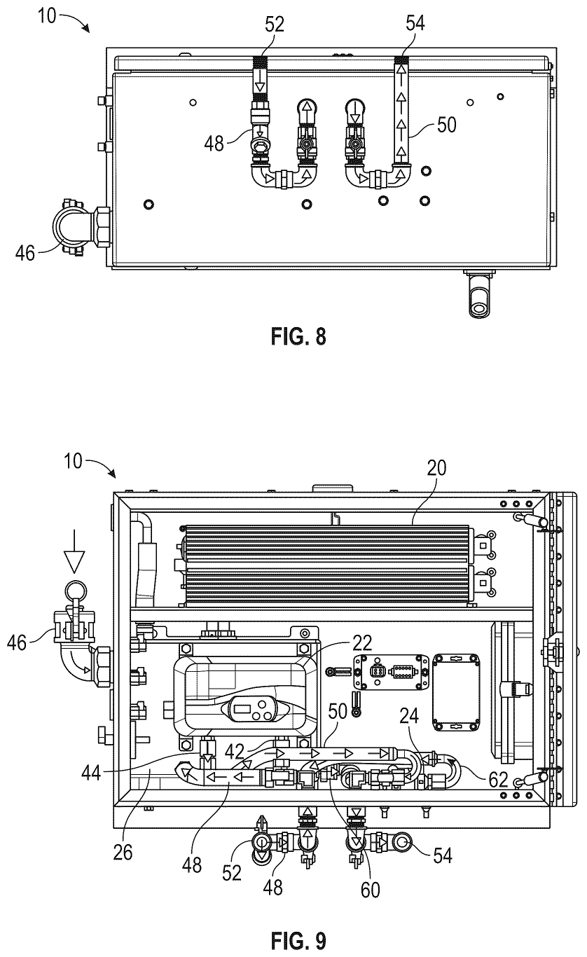

Referring to FIGS. 2-7, the heating apparatus 10 broadly includes an electric inverter 20, an electric liquid heater 22, and an electric liquid pump 24. In some embodiments, the electric liquid heater 22 may be a resistance-type alternating current (AC) electric liquid heater electrically connected to the electric inverter 20, allowing it to receive alternating current from the electric inverter 20 when the electric inverter 20 is activated. The electric liquid pump 24 may be a direct current electric liquid pump 24 electrically connected to the source of DC electric power. The heating apparatus 10 may also include an accumulator 26 and a housing 28. To protect components of the transport heating apparatus 10 from the environment during transportation on the truck 12, the housing 28 is provided to cover the components. The housing 28 has a cabinet 30 supported by legs 32, and a door 34.

The electric inverter 20 is electrically connected to the DC electric power source of the truck 12 to convert the direct current from the DC electric power source to alternating current. In one embodiment, the inverter 20 may be a 5-kilowatt, pure sine inverter that inverts the 12 DC voltage from the source to a 120-volt, 30-amp alternating current (AC) supply. The electric inverter 20 may, in some embodiments, be electrically connected to the DC electric power source via suitable conduits that are connected to the inverter 20 at connections 36 and 38, allowing the DC electric power source to supply DC current to the electric inverter 20. The electric inverter 20 may be supported on a shelf 40 of the cabinet 30. An exemplary electric inverter is commercially available from Aims Power of Reno, Nevada, under model number PWRIG500012120S.

The resistance-type AC electric liquid heater 22 is electrically connected to the output of the electric inverter 20. The liquid heater 22 has an inlet 42 and an outlet 44. The electric liquid heater 22 is capable of maintaining the heating liquid at a pre-set maximum operating temperature and is compatible with various heat transfer fluids, including ethylene glycol and propylene glycol.

The liquid heater 22 is of the type that utilizes resistive heating elements to heat the heating liquid. These elements are made of materials that resist the flow of electricity, converting the electrical energy into heat. The more power is applied to the elements, the hotter they become, and this heat is transferred to the heating liquid passing over them. As the heating liquid flows through the liquid heater 22, the heating liquid absorbs heat from the resistive elements. The heating liquid is heated almost instantaneously due to rapid energy transfer. An exemplary resistance-type AC electric liquid heater is commercially available from Rheem Sales Company, Inc. of Atlanta, Georgia, under model number EEM12004-TRNSP.

The pump 24 may be a pump capable of moving the heating liquid through the heating system 10. Specifically, the pump 24 is a continuous-duty-rated pump selected to handle the maximum operating temperature and the required flow rate of the heating system, ensuring that the circulation of the heating liquid, such as glycol, is maintained throughout the system.

The liquid accumulator 26 can be of any suitable size. In one version, the liquid accumulator 26 has a capacity of 2.9 gallons. The liquid accumulator 26 has a fill port extending 46 from one side of the cabinet 30 to facilitate supplying heating liquid to the heater system 10.

The connection between the components will now be described. The heating system 10 has an inlet tube 48 and an outlet tube 50, with the inlet tube 48 having an inlet 52 that extends from the cabinet 30 and the outlet tube 50 having an outlet 54 that extends from the cabinet 30. The inlet 52 is connected to an outlet 56 of the heat exchange tube 16, and the outlet 54 is connected to an inlet 58 of the heat exchange tube 16 (FIG. 1). The inlet tube 48 is fluidly connected to the liquid accumulator 26. An inlet pump tube 60 extends from the liquid accumulator 26 and is fluidly connected to the inlet of the pump 24. An outlet pump tube 62 is fluidly connected to the outlet of the pump 24 and is fluidly connected to the inlet 42 of the liquid heater 22. The outlet tube 50 extends from the outlet of the liquid heater 22 to the exterior of the cabinet 30.

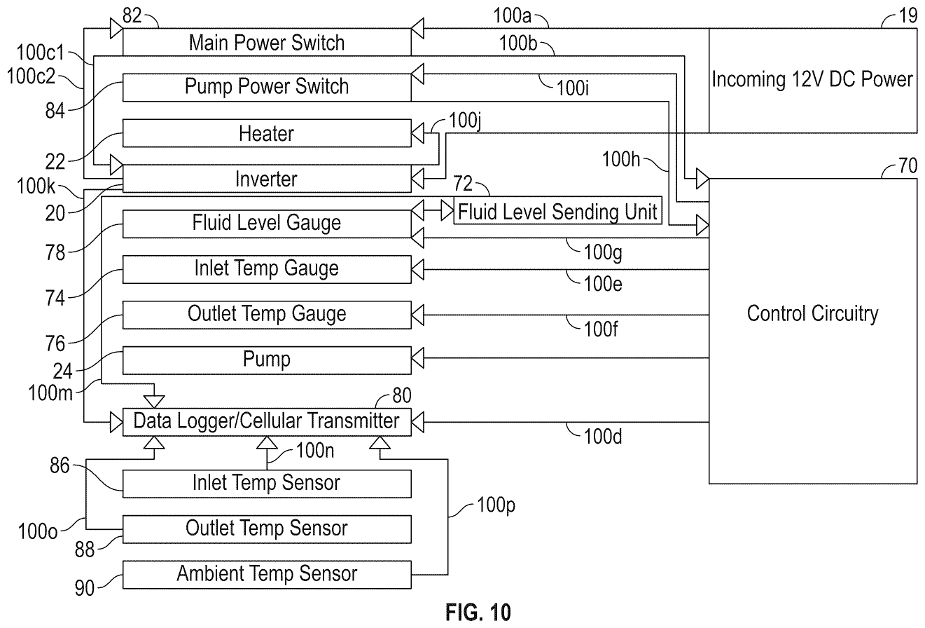

FIG. 10 illustrates a block diagram of at least a portion of the heater system 10. The heater system 10 is provided with control circuitry 70, the electric inverter 20, the electric liquid heater 22, the pump 24, a fluid level sending unit 72, an inlet temperature gauge 74, an outlet temperature gauge 76, a fluid level gauge 78, a data logger 80, a main power switch 82, a pump power switch 84, an inlet temperature sensor 86, an outlet temperature sensor 88, and an ambient temperature sensor 90.

The source 19 of DC power is connected to the main power switch 82 via a path 100a. The main power switch 82 is connected to the control circuit 70 via a path 100 b. The main power switch 82 is also connected to the inverter 20 via paths 100c1 and 100c2. The main power switch 82 supplies 12V DC power to the control circuitry 70 via the path 100b, but also functions as a remote on/off switch for the inverter 20. From the control circuitry, power and ground are supplied to the data logger 80 via a path 100d, the inlet gauge 74 via a path 100e, the outlet gauge 76 via a path 100f, and the fluid level gauge 78 via a path 100g. The control circuitry 70 may also supply separate power to the inlet temperature gauge 74, the outlet gauge 76, and the fluid level gauge 78 for backlights.

The pump power switch 84 serves as a remote switch for the pump 24, operating through the control circuitry 70. In particular, the control circuitry 70 may have an output via path 100i to the pump power switch 84 and an input via path 100h, which comes from the pump power switch 84, to activate the pump 24.

Once the main power switch 82 is turned to the “On” position, the heater 22 will receive AC power via a path 100j from the inverter 20. For the heater 22 to power on, the pump power switch 84 must be turned to the “on” position. Once the heater 22 senses flow via a flow meter (not shown), the heater 22 will power on and begin its 5-minute startup cycle. This allows heated fluid that has already preheated the trailer to be cycled through, preventing the system from being shocked by cold fluid.

The data logger 80 monitors the output voltage of the inverter 20 via the path 100k. The fluid level sending unit 72 also communicates with the data logger 80 and the fluid level gauge 78 via a path 100m. In this manner, the data logger 80 can monitor the function of the inverter 20 and help to ensure that the heater 22 is operating properly. The data logger 80 also monitors the output of the inlet temperature sensor 86 via the path 100n, the output of the outlet temperature sensor 88 via the path 100o, and the output of the ambient temperature sensor 90 via the path 100p. Furthermore, the data logger 80 is configured to communicate wirelessly with a separate digital driver data logger (such as a Motive ELD, People Net, Magnum Log, or Trimble device) that the driver logs into prior to operating the truck. This communication allows the data logger 80 to transmit performance data, including temperature variances, to the digital driver data logger.

The fluid level gauge 78, the inlet temperature gauge 74, and the outlet temperature gauge 76 may include sensors separate from the inlet temperature sensor 86 and the outlet temperature sensor 88. However, the sensor for the inlet temperature gauge 74 and the inlet temperature sensor 88 may be located in the same position on the inlet tube 48, via a first T-connection, for example. Similarly, the sensor for the outlet temperature gauge 76 and the outlet temperature sensor 88 may also be at the same location on the outlet tube 50 via a second T-connection.

In some embodiments, the data logger 80 may only receive power from the control circuitry 70.

The paths 100a-100p can be conductive wires and/or wireless communications. For example, in some embodiments, the electric inverter 20, the pump 24, the fluid level sending unit 72, the inlet temperature gauge 74, the outlet temperature gauge 76, the fluid level gauge 78, and the data logger 80 may have a wireless transceiver conforming to the requirements of a Wi-Fi protocol that are operable to communicate with each other. Several versions of the Wi-Fi protocol are described in connection with the identifiers IEEE 802.11a/b/g/n/ac/ax. Such Wi-Fi protocols are known by those skilled in the art. In another embodiment, the data logger 80 is configured with a BLUETOOTH transceiver for wireless communication with the digital driver data logger. Thus, no further comments are deemed necessary herein concerning how to make and use the Wi-Fi protocols.

The main power switch 82 is operable to activate the inverter 20, supplying alternating current to the heater 22, and to deactivate the inverter 20, ceasing to supply alternating current to the heater 22. The pump power switch 84 and the control circuitry 70 are also operable to activate the pump 24, allowing the fluid to move through the inlet of the liquid heater 22, out the outlet of the liquid heater 22, and through the heat exchange tube 16. The pump power switch 84 and the control circuit 70 are also operable to deactivate the pump 24, thereby ceasing the movement of fluid through the liquid heater 22 and the heat exchange tube 16.

The data logger 80 is also capable of collecting various performance data indicative of the operational performance of the heating system 10. The performance data can be any data that is indicative of how the heating system 10 is performing. The performance data can be time-based data streams in which data points of the performance data are periodically or non-periodically gathered and time-stamped. The data logger may include a cellular transmitter for transmitting the performance data to a monitoring computer. The performance data can be transmitted to the monitoring computer using any suitable protocol, such as push technology, pull technology, or a combination thereof. The monitoring computer can be provided in various forms, such as a cellular telephone, tablet computer, desktop computer, server computer, or the like. In one embodiment, the monitoring computer may be located to communicate directly with the driver while on the road, allowing the driver to be alerted to non-protocol operations of the heater, such as cooling of the payload and/or overheating of the payload or the heater not functioning. In a further embodiment, the communication between the data logger 80 and the digital driver data logger is utilized to alert the driver to temperature variances in the heating system 10 or the payload while the driver is operating the vehicle. In another embodiment, the driver may be able to adjust or modify the operation of the heater while in transit.

In some embodiments, the heater system 10 is provided with a plurality of sensors for collecting aspects of the performance data. As shown in FIG. 10, the plurality of sensors may include the fluid level sending unit 72 and sensors associated with the inlet temperature gauge 74 and the outlet temperature gauge 76. The fluid level sending unit 72 may communicate with the interior of the liquid accumulator 26 to measure the liquid level within the liquid accumulator 26. The fluid level sending unit 72 may be implemented in various manners and may be a contact sensor, such as a float, or a non-contact sensor, such as a pulse radar or a capacitive sensor. The fluid level sending unit 72 may operate to pass data generated by the fluid level sending unit 72 to the data logger 80.

The sensor associated with the inlet temperature gauge 74 and the inlet temperature sensor 86 may be positioned in the inlet tube 48, in direct contact with the heating liquid. The sensor associated with the inlet temperature gauge 76 and the inlet temperature sensor 86 may be constructed in various manners. In some embodiments, the sensor associated with the inlet temperature gauge 74 and the inlet temperature sensor 86 may include a thermistor or thermocouple.

The sensor associated with the outlet temperature gauge 76 and the outlet temperature sensor 88 may be positioned in the outlet tube 50, in direct contact with the heating liquid. The sensor associated with the outlet temperature gauge 76 and the outlet temperature sensor 88 may be constructed in various manners. In some embodiments, the sensor associated with the inlet temperature gauge 76 and the outlet temperature sensor 88 may include a thermistor or thermocouple.

The heater system 10 may also include the data logger 80 that communicates with the control circuitry 70. The data logger 80 may include circuitry operable to receive, store, time-stamp, and transmit the performance data. As discussed above, the performance data can be represented by time-based data streams in which data points of the performance data are periodically or non-periodically gathered and time-stamped.

Circuitry, as used herein, may be analog and/or digital components, one or more suitably programmed processors (e.g., microprocessors), and associated hardware and software, or hardwired logic. Also, “circuitry” may perform one or more functions. The term “circuitry” encompasses a range of components, including hardware such as a processor (e.g., a microprocessor), an application-specific integrated circuit (ASIC), a field-programmable gate array (FPGA), and combinations of hardware and software, among others. The term “processor,” as used herein, means a single processor or multiple processors working independently or together to perform a task collectively.

Software or hardwired logic may include one or more computer-readable instructions that, when executed by a processor, may cause the processor to perform a specified function. It should be understood that the algorithms described herein may be stored on one or more non-transitory computer-readable mediums. Exemplary non-transitory computer-readable mediums may include random access memory, read-only memory, flash memory, and/or the like. Such non-transitory computer-readable mediums may be electrically based, optically based, magnetically based, and/or the like.

In operation, the transport heating apparatus 10 is filled with the heating liquid via the fill port 46. The heating fluid is confined within the heating apparatus 10 and the heat exchange tube 16. Upon activation of the main power switch 82 and the pump power switch 84, the heating liquid passes through the liquid heater 22, where it is heated by the heating element(s) disposed in a heat exchange relationship with the liquid. The pump 24 and the liquid heater 22 are energized via the source 19 and the inverter 20.

From the above description, it is clear that the inventive concept(s) disclosed herein are well adapted to carry out the objects and to attain the advantages mentioned herein, as well as those inherent in the inventive concept disclosed herein. While exemplary embodiments of the inventive concept disclosed herein have been described for purposes of this disclosure, it will be understood that numerous changes may be made that will readily suggest themselves to those skilled in the art and which are accomplished without departing from the scope of the inventive concept disclosed herein and defined by the appended claims.

What is claimed is:

1. A heating system in combination with a truck having a source of direct current DC electric power and a liquid transport trailer having a heat exchange tube with an inlet end, an outlet end, and a heating liquid disposed in the heat exchange tube, the heating system comprising:
an electric inverter electrically connected to the DC electric power source of the tractor to change the direct current to alternating current;
a resistance-type AC electric liquid heater having an inlet fluidly connected to the outlet of the heat exchange tube and an outlet, the AC electric liquid heater electrically connected to the electric inverter; and
an electric liquid pump having an inlet fluidly connected to the outlet of the heat exchange tube and an outlet fluidly connected to the inlet of the heater, the pump electrically connected to the inverter,
wherein the electric liquid heater maintains the heating liquid at a temperature within a pre-set operational range that is sufficient to maintain the cargo at a desired temperature.

2. The heating system of claim 1, further comprising a control circuitry coupled to the pump and to the liquid heater for automatic deactivation of both the pump and the liquid heater in response to elevation of the temperature of the liquid above a predetermined temperature.

3. The heating system of claim 1, wherein the electric inverter is a pure sine inverter.

4. The heating system of claim 3, wherein the inverter is a 5-kilowatt electric inverter.

5. The heating system of claim 4, wherein the DC electric power source of the tractor is an alternator of the tractor supplying a 12 DC voltage, and wherein the electric inverter changes the 12 DC voltage to a 120-volt, 30-amp AC supply.

6. The heating system of claim 1, wherein the heating liquid is glycol.

7. The heating system of claim 1, wherein the heating liquid is ethylene glycol.

8. The heating system of claim 1, wherein the heating liquid is propylene glycol.

9. The heating system of claim 1, further comprising a liquid accumulator in fluid communication with the closed-loop tube and the electric heater.

10. The heating system of claim 1, further comprising a liquid accumulator having an inlet in fluid communication with the outlet of the closed-loop tube and an outlet in fluid communication with the inlet of the liquid pump.

11. The heater system of claim 1, further comprising a weatherproof housing, with venting and sensors of heat inbound, heat outbound, ambient temperature, and level.

12. A method for heating a fluid circulating through a liquid transport trailer while in transit, the trailer being connected to a truck having a source of direct current (DC) electric power, the method comprising:
sourcing DC power from the truck's DC electric power source;
converting the DC power to alternating current (AC) using an electric inverter electrically connected to the DC power source;
activating a liquid pump using DC power to initiate circulation of a heating liquid through a closed-loop heat exchange tube in the trailer and a resistance-type AC electric liquid heater;
activating the AC electric liquid heater to begin a heating cycle, wherein the heater is supplied with AC power from the electric inverter;
heating the circulating liquid with the resistance-type AC electric liquid heater to maintain the heating liquid at a temperature within a pre-set operational range that is sufficient to maintain the cargo at a desired temperature; and
continuously circulating the heated liquid through the heat exchange tube to maintain the temperature of a temperature-sensitive material being transported in the trailer.

13. The method of claim 12, further comprising delaying the activation of the AC electric liquid heater until the heater senses fluid flow through the AC electric liquid heater.

14. The method of claim 13, wherein the activation of the heater is delayed by a startup cycle to allow heated fluid to cycle through the system and avoid shocking the system with cold fluid.

15. The method of claim 12, further comprising deactivating both the electric liquid pump and the AC electric liquid heater automatically via control circuitry in response to the temperature of the circulating liquid exceeding a predetermined temperature.

16. The method of claim 12, further comprising providing the AC electric liquid heater with an input device to allow a driver to set the desired temperature of the temperature-sensitive material at the time of loading.

17. The method of claim 12, wherein the converting step changes the 12 Volt DC power to a 120-volt, 30-amp AC supply.

18. The method of claim 12, further comprising:
monitoring performance data of the heating system using a data logger; and
time-stamping the performance data.

19. The method of claim 18, further comprising:
transmitting the performance data via a cellular transmitter from the data logger to a remote monitoring computer;
alerting a driver to non-protocol operations of the heater system based on the transmitted performance data; and
receiving a command from the monitoring computer and adjusting or modifying the operation of the heater while in transit based on the command.
